(19) United States
(12) Patent Application Publication
(10) Pub. No.: US 2003/0013364 A1
(43) Pub. Date: Jan. 16, 2003

(54) Structure for producing removable paths and/or platforms

(75) Inventor: Francesco Ferraiolo, Fabbri-Bologna (IT)

Correspondence Address: SUGHRUE, MION, ZINN, MACPEAK & SEAS, PLLC, 2100 Pennsylvania Avenue, N.W., Washington, DC, 20037-3202, US

(73) Assignee: OFFICINE MACCAFERRI SPA

(21) Appl. No.: 10/192,733

(22) Filed: Jul. 11, 2002

(30) Foreign Application Priority Data
Jul. 12, 2001 (IT) BO2001A000437

(51) Int. Cl. B32B 3/00; B32B 5/02; B32B 9/00; D04H 1/00; D04H 3/00; D04H 5/00; D04H 13/00

(52) U.S. Cl. 442/59

(57) ABSTRACT

A structure comprising at least one layer of non-woven fabric material connected to one or more flexible wire netting elements is laid on an area of ground in order to produce removable paths and/or platforms. The non-woven fabric (3) is connected to the wire netting (2) by engagement means which facilitate the connection thereof.

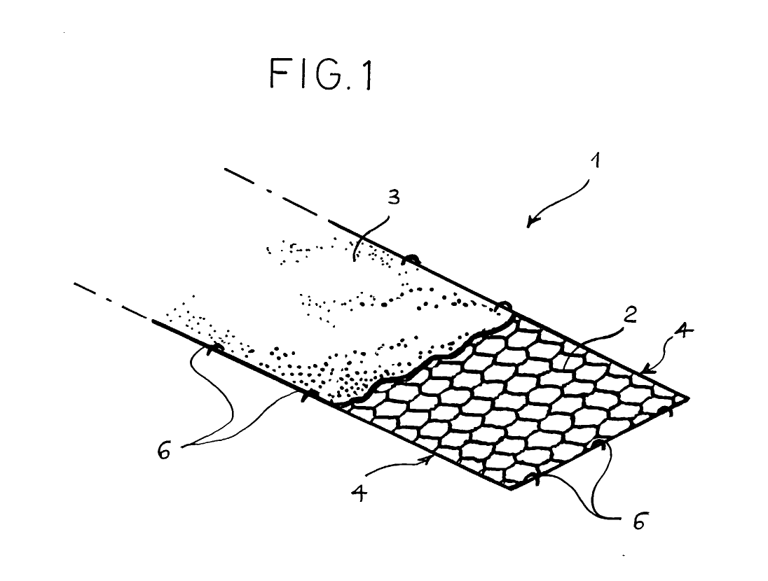

The present invention relates to the field of structures for producing removable support surfaces and, in particular, for producing paths and/or platforms for motor vehicles to be placed temporarily on broken, muddy or swampy ground.

When an area of ground does not have sufficient characteristics of compactness and solidity, it is known to arrange temporary surfaces, for example produced by means of planks of wood, for the transit, deposit and/or parking of heavy equipment and vehicles. The main drawbacks of such solutions are the complexity of the laying, fixing, interconnection and removal from the ground, of the temporary surfaces, the necessary high cost both in terms of time and in terms of raw material in the case of temporary surfaces of large area, and the gradual damaging of the surfaces as a result of prolonged use and long exposure to atmospheric agents.

In order to overcome the above problems, various types of mats have been developed which generally employ panels produced from multi-layer materials and interconnected with each other in various configurations to form a single continuous or almost continuous path. These types of mats, however, also have numerous drawbacks, linked above all to the frequent need to provide several layers thereof in order to guarantee sufficient stability of the path, and to the presence of the areas of junction between the various panels which allow water to filter through and form unwanted mud on their surface.

To facilitate the transport and laying of mats for producing removable paths and/or platforms, panels connected to one another and produced from plastics or resinous material have been produced which enable the path to be configured easily according to the required dimensions, and which permit a more uniform distribution of the surface loads. In this case also, however, numerous problems which are common to all the solutions of known type remain unsolved, linked to the time and costs involved in the laying, mutual interconnection of the panels, and their recovery after use.

In order to solve the above problems, the Applicant carried out many experiments with numerous types of structure produced with different types of materials. None of the results obtained, however, succeeded in solving the problems mentioned above and linked to such structures.

The Applicant, normally operating in the technical field of containment structures for producing embankments, bastions, barriers and other similar elements, has a knowledge of numerous embodiments of containment structures comprising a layer of retaining material and flexible reinforcing means.

During the above-mentioned experiments, therefore, the Applicant also tried out various structures comprising the characteristics mentioned above, encountering surprising effects in the results achieved and in the advantages obtained.

The principal aim of the present invention is therefore that of remedying the drawbacks of the products of known type, by providing a structure for producing path and/or platform surfaces which is economical, easy and quick to deploy and remove, and which has a high strength over time and also after prolonged use.

Another aim of the present invention is that of producing a structure which is easily stored and transportable on site, and which is of dimensions such as not to require further connection operations in order to allow, for example, the transit of vehicles of large dimensions.

A further aim of the present invention is that of producing a structure which, after use, can be rapidly and easily recovered and therefore re-used at another working site.

To fulfil the above-mentioned aims, the subject of the present invention is the use of a structure comprising at least one layer of non-woven fabric material connected to one or more flexible wire netting elements, characterised in that it comprises laying on an area of ground at least one layer of said structure to produce removable paths and/or platforms.

Further characteristics and advantages will become clear from the following detailed description of an embodiment of the invention, with reference to the appended drawing, provided purely by way of non-limiting example, showing diagrammatically in perspective view a surface for the passage of motor vehicles according to the present invention.

With reference to the drawings, a structure 1 for producing paths and/or platforms for motor vehicles comprises a layer of retaining material, for example, but not by way of limitation, a non-woven fabric, preferably a geotextile layer 3 composed of synthetic polymers of the type commonly commercially available. The geotextile layer 3 is engaged with reinforcing means, for example, but not by way of limitation, wire netting 2, preferably wire netting of the double twist hexagonal mesh type, in such a way as to produce with the latter a single flexible structure.

The reinforcing means may of course also comprise different elements, such as, for example, but not by way of limitation, geosynthetic materials, geogrids, bars, boards or reinforcing panels disposed longitudinally or transversely with respect to the direction of development of the structure 1, provided that the aims of the present invention can still be fulfilled and its advantages maintained.

In one embodiment of the present invention, the geotextile layer 3, like the wire netting 2, has a rectangular conformation, elongate in a preferential direction, and a width, for example, but not necessarily, of around 3 meters, preferably of around 2.80 meters, and in any case of a width such as to satisfy the requirements for supporting vehicles and/or objects of any dimensions.

One of the principal advantages of the present invention lies in the technical characteristic, for example the coefficient of flexibility, of the materials which are comprised within the structure 1 for producing paths and/or platforms, and in their form. These characteristics enable said structure 1 to be stored and transported easily in a rolled-up position, thus reducing the space occupied and the time taken for the laying and removal of the entire path or platform.

The geotextile layer 3 is engaged with the wire netting 2 along both the lateral extremities 4 of the latter by engagement means, for example, but not by way of limitation, welding, clips, hooks or any other engagement means which provides strong and prolonged adherence over time between the netting 2 and the geotextile layer 3.

In use, a structure 1 for producing paths or platforms according to the present invention is transported towards an area of ground comprising a particularly difficult surface for the transit or positioning of vehicles or equipment, for example, an area of broken, muddy or swampy ground. The structure 1 is then laid so that the wire netting 2 faces directly onto the ground. Said arrangement makes it possible to increase the connection of the structure 1 to the ground itself, and in this way to avoid troublesome and dangerous sliding of the structure itself.

During the transportation step the structure 1 is in its rolled-up position so as to adopt a cylindrical or similar configuration. The structure 1 can be transported by means of ordinary goods vehicles, for example lorries, and then deposited on the ground and spread out manually or, preferably, by moving means such as cranes, excavators or tractors. Alternatively, the structure 1 may be transported directly by vehicles comprising devices particularly adapted for supporting and laying, by automatic unrolling, the temporary structure 1 and for rapidly producing a removable path or platform.

In order to facilitate the operations of laying said structure 1, the starting end of the structure 1 is connected to the ground by anchoring and/or clamping means 6, such as pegs, bolts, clips, cramps or the like, so as to allow more uniform deployment of the structure 1, avoiding any possible phenomena of longitudinal crinkling.

In a particular embodiment of the present invention, the removable structure 1 is transported on a heavy vehicle comprising a wheeled framework on its front portion on which the structure 1 is mounted in its rolled-up form. During the normal movement of the heavy vehicle, the removable structure 1 is unrolled in front of the vehicle, such that the latter exerts traction with the front wheels on the structure 1 itself and facilitates the unrolling thereof and its connection with the ground. Once the laying step is completed, in the case where a structure of greater extent than that used was loaded on the vehicle, the structure 1 is severed in a position such as to liberate the portion already deployed from the portion still loaded on the vehicle, and to allow the vehicle to lay further successive paths or platforms.

If necessary, the finishing end of the structure 1 may be connected to the ground as described above for the starting end, thus further reducing the probability of any sliding action of the entire support surface with respect to the ground.

In order to facilitate the loading of the structure 1 on similar automated laying devices, the longitudinal extremities of the geotextile layer 3 and of the wire netting 2 of the structure 1 thus composed may also be engaged with one another. In this way, harmful phenomena of crinkling of the ends of the flexible netting 2, which make the operation of loading the structure 1 on said devices slower and more complex, are avoided.

In one embodiment of the present invention, the lateral extremities 4 of the wire netting 2 are connected to the ground by means of U-shaped clips 6 so as to reduce substantially any crinkling effects due principally to the presence of loads, vehicles or equipment on its surface. The clips 6 may of course also be disposed in positions other than the lateral extremities 4, for example within the area of the structure 1, to improve its adherence to the ground.

With this step completed, the removable path is ready for use in the case where the vehicles in transit are of suitable width, whereas, in the case where the vehicles have a live axle width greater than the width of the path, another similar removable structure may be laid alongside the first so as to widen the carriageway of the path.

In another embodiment of the present invention, several removable structures of predetermined length are placed alongside one another so as to produce a substantially square support platform. Said platform is then used as a landing area for powered aircraft such as, for example, helicopters or the like.

The principal advantage of the present invention in similar applications lies in the simplicity and speed of laying a platform, and in its consequent easy and rapid removal, extremely useful in particular emergency situations.

With the principle of the invention remaining unchanged, the embodiments and the details of production may of course vary widely with respect to what has been described, without thereby departing from the scope of the present invention.

1. The use of a structure comprising at least one layer of non-woven fabric material connected to one or more flexible wire netting elements, characterised in that it comprises laying on an area of ground at least one layer of said structure in order to produce removable paths and/or platforms.

2. The use of a structure according to claim 1, characterised in that the non-woven fabric (3) is connected to the wire netting (2) by engagement means.

3. A method for laying a structure comprising at least one layer of non-woven fabric material (3) connected to one or more flexible wire netting elements (2), characterised in that it comprises the following steps:
a) arranging said structure (1) in proximity to an area of ground;
b) laying the starting end of the structure (1) so that the wire netting (2) faces directly onto the ground;
c) connecting the starting end of the structure (1) to an area of ground by first clamping means (6);
d) extending the structure (1) in a predetermined direction and to a predetermined length; and
e) connecting the finishing end of the structure (1) to the ground by employing second clamping means (6).

4. A method according to claim 3, characterised in that the structure (1) is loaded, in rolled-up form, on a motor vehicle comprising automated devices for laying said structure (1).

5. A method according to claim 4, characterised in that it further comprises the following steps:
a) loading the structure (1) on the automated devices of the motor vehicle;
b) positioning one end of the structure (1) beneath the front wheels of said vehicle;
c) advancing the vehicle in a direction such that the structure (1) is laid on the ground and the wheels of the vehicle pass over the laid structure (1) and facilitate its connection to the ground; and
d) interrupting the advance of the vehicle and severing the structure (1) so as to separate the portion of structure (1) laid on the ground from the portion still loaded on the vehicle.
